(19) United States
(12) Patent Application Publication
(10) Pub. No.: US 2026/0168616 A1
(43) Pub. Date: Jun. 18, 2026

(54) HOOK STRUCTURE FOR CLAMPING TO BRICK WALL

(71) Applicant: Taiwan Hong Chen Hardware Industry Ltd., Changhua County (TW)

(72) Inventor: Tai-Chen CHEN, Changhua County (TW)

(21) Appl. No.: 18/979,879

(22) Filed: Dec. 13, 2024

(51) Int. Cl. F16M 13/02

(52) U.S. Cl. CPC F16M 13/022

(57) ABSTRACT

A hook structure for clamping to brick wall, including a suspending body pin connected to a hook body. The top portion of the suspending body is provided with an upper gripping teeth, and is further provided with a plurality of positioning holes, which enable the hook body to be pivoted in a horizontal state and adjustment in height thereof. The rear and front of the hook body is provided with a lower gripping teeth and a curved hook respectively. The hook body operates on a lever principle, with the upper gripping teeth gripping the top surface of a brick in a brick wall, and the lower gripping teeth gripping the bottom surface of the brick, thus, the heavier the weight of an object suspended on the curved hook, the stronger the gripping strength of the lower gripping teeth on the hook body gripping the bottom surface of the brick.

### BACKGROUND OF THE INVENTION

### (a) Field of the Invention

The present invention relates to an hook structure for clamping to a brick wall, and more specifically to an hook structure for clamping to brick wall, comprising a suspending body pin connected to a hook body. The height of the hook body can be adjusted according to the height of a brick, and the suspending body is suspended on the top surface of the brick. The hook body operates on a lever principle, whereby the heavier the weight of an object suspended on the front end of the hook body, the stronger the gripping strength of the rear end of the hook body on the bottom surface of the brick.

### (b) Description of the Prior Art

As is well known, the most common method for hanging an object on a wall is to drive a nail into the wall and hang the object thereon. However, a certain amount of force is required to drive the nail into the wall, resulting in the main drawback of causing damage to the wall, often causing cracks, especially if the wall is a brick wall. Although the above hanging method has been replaced with a hook and loop fastening strip that is attached to the wall, such a method can only be used on smooth walls, and, in general, hook and loop fastening strips cannot be attached to unplastered brick walls or walls without tiles.

As a result, the industry has developed a hook for clamping to a brick wall, as shown in FIGS. 1, 2, and 4, wherein a hook 10 mainly comprises a main body 11, that is a plate, the top portion of which is wide and the bottom portion is narrow. The front face of the main body 11 has two protruding hooks 12, and the top portion is formed as a backward extending inverted U-shaped body 13, the end of which is configured with serrated gripping teeth 14. The bottom end of the main body 11 is configured with two spring pieces 15, the outer ends of which are elastic, and the two spring pieces 15 are formed as an integral body with the main body 11.

Referring to FIGS. 3 and 5, when in use, the main body 11 is adjacent to a brick wall 20, with the gripping teeth 14 of the main body 11 gripping a top surface 211 of a brick 21 in a brick wall 20. The two spring pieces 15 of the main body 11 abut against a bottom surface 212 of the brick 21, causing the main body 11 to grip onto the brick 21. The two protruding hooks 12 on the front face of the main body 11 enable suspending objects thereon, thereby eliminating the need to drive nails into the brick wall 20. and thus avoiding damaging the brick wall 20.

However, the height of the bricks 21 of the brick wall 20 is different in each region, and the main body 11 cannot be adjusted to suit the height of the bricks of every region. When the height of the brick 21 is much greater than the distance from the gripping teeth 14 to the spring pieces 15, then the gripping teeth 14 are only able to hook onto the top surface 211 of the brick 21, and the spring pieces 15 are unable to abut against the bottom surface 212 of the brick 21. On the other hand, when the height of the brick 21 is much smaller than the distance from the gripping teeth 14 to the spring pieces 15, then it is completely impossible to attach the hook 10 to the brick wall 20. Hence, use of the hook 10 is extremely bothersome to consumers and troublesome to the industry. In addition, the traditional hook 10 also has the shortcoming of falling off when loaded with a relatively heavy object.

Subsequently, although some manufacturers have divided the main body of a hook into two pieces with the addition of a tightening device, which enable adjusting the height and length thereof to match the height of a brick; however, the hook still tends to come loose after a long period of use, and thus ineffective.

### SUMMARY OF THE INVENTION

The present invention provides an hook structure for clamping to brick wall, comprising a suspending body, which is a plate, the top portion of which is configured with a backward bent inverted U-shaped body. The end of the inverted U-shaped body is configured with serrated upper gripping teeth, and a protruding plate is provided on each side of the suspending body.

The present invention is characterized in that: the suspending body is pin connected to a horizontal hook body, and each of the protruding plates is provided with a plurality of positioning holes. The hook body is pin connected between the two protruding plates, and two sides of the hook body are respectively configured with a lug, which are joined to an aligned pair of the positioning holes of the protruding plates. The rear end of the hook body is configured with a hook claw, the end of which is configured with serrated lower gripping teeth, and the front end of the hook body has a curved hook.

Accordingly, the upper gripping teeth grip the top surface of a brick in a brick wall, and the plurality of positioning holes enable adjusting the height position of the hook body. The lower gripping teeth of the hook body grip the bottom surface of the brick, and the heavier the weight of an object suspended on the curved hook, the stronger the gripping strength of the lower gripping teeth of the hook body on the bottom surface of the brick.

The main object of the present invention lies in pin connecting the hook body to the suspending body, wherein the height of the hook body can be adjusted according to the height of a brick so as to match the height of nearly all regional bricks.

A second object of the present invention lies in when suspending the suspending body on a brick, the hook body operates on a lever principle, whereby the heavier the weight of an object suspended on the hook body, the stronger the gripping strength of the hook body on the bottom surface of the brick, thereby eliminating the shortcomings of traditional hooks which fall off when loaded with heavy objects.

Another object of the present invention lies in eliminating the need to drive nails into a brick wall, and thus preventing damage thereto.

Yet another object of the present invention lies in the lower gripping teeth exerting two forces to grip the bottom surface of a brick, i.e.,after tightening a butterfly nut onto a bolt column, one of the forces is exerted by the lower gripping teeth of the hook claw gripping the bottom surface of a brick, as for the other force, the weight of an object suspended from the curved hook causes a lever principle to react on the lower gripping teeth to push upward against the bottom surface of the brick.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is three-dimensional schematic view of a hook for clamping to a brick wall of the prior art.

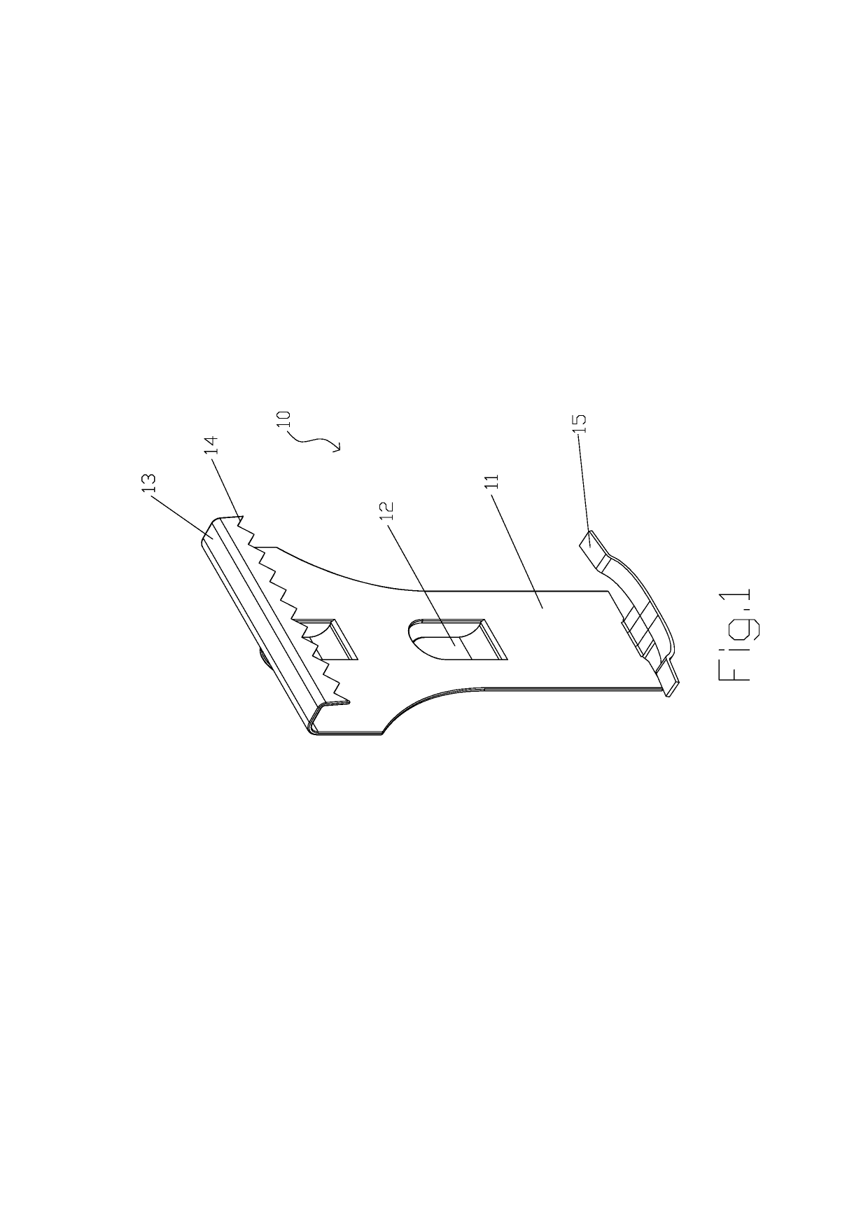

FIG. 2 is a side schematic view of the hook for clamping to a brick wall of the prior art.

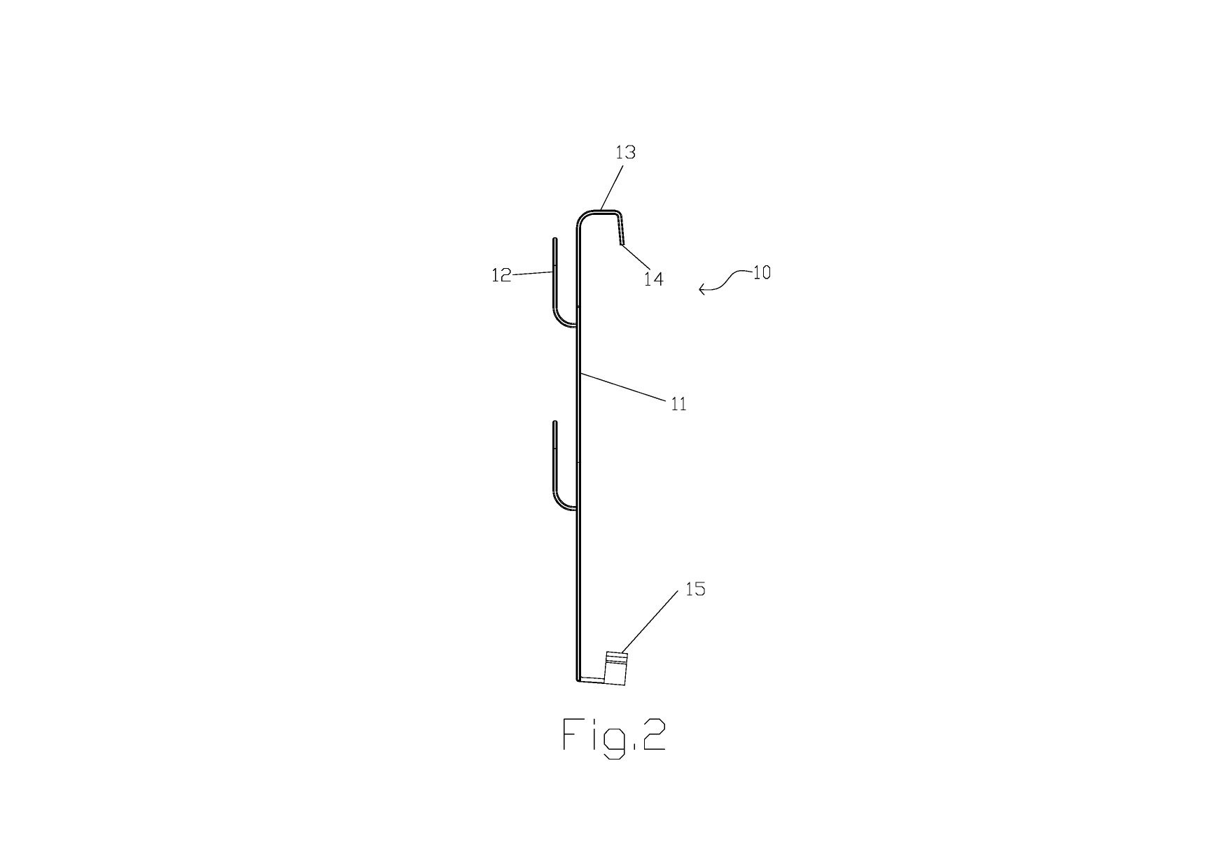

FIG. 3 is three-dimensional schematic view of the hook for clamping to a brick wall of the prior art assembled on a single brick.

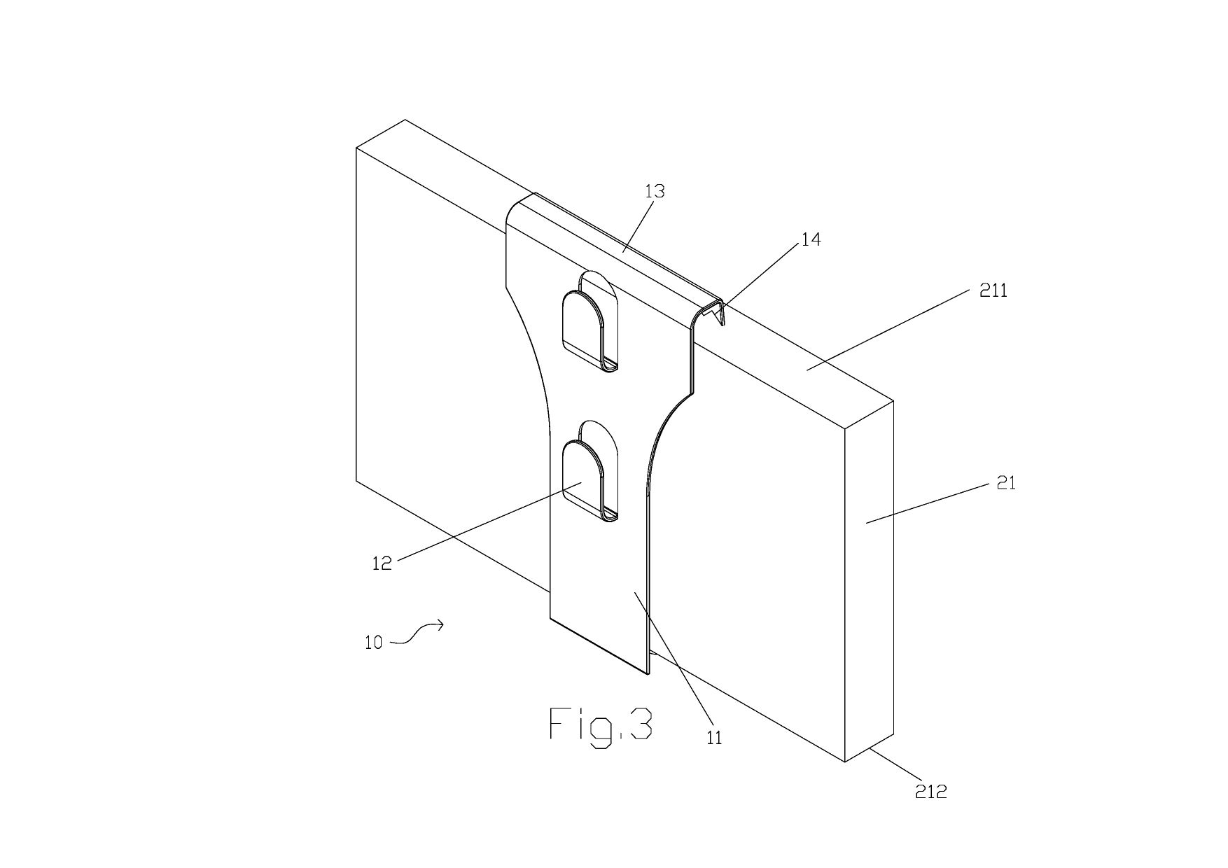

FIG. 4 is side schematic view of the hook for clamping to a brick wall of the prior art assembled on a single brick.

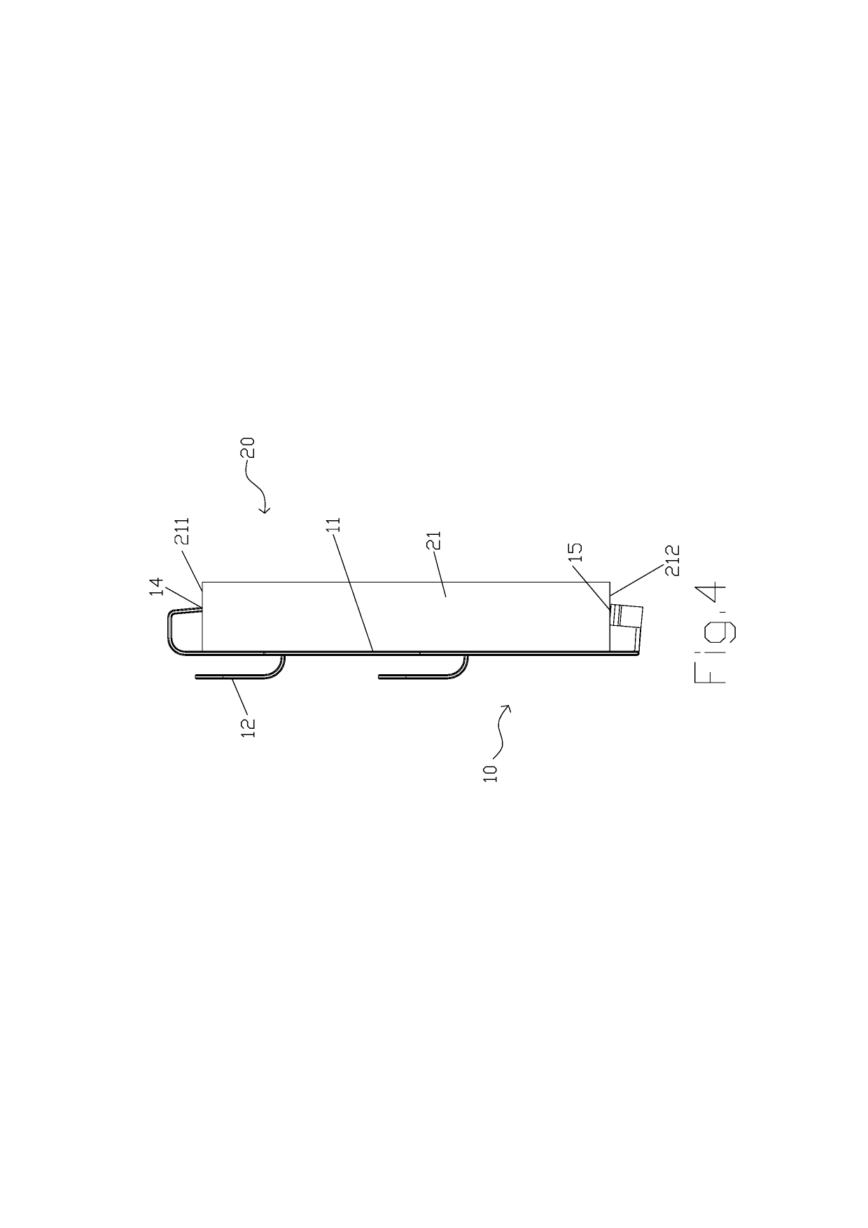

FIG. 5 is three-dimensional schematic view of the hook for clamping to a brick wall of the prior art assembled on a brick wall.

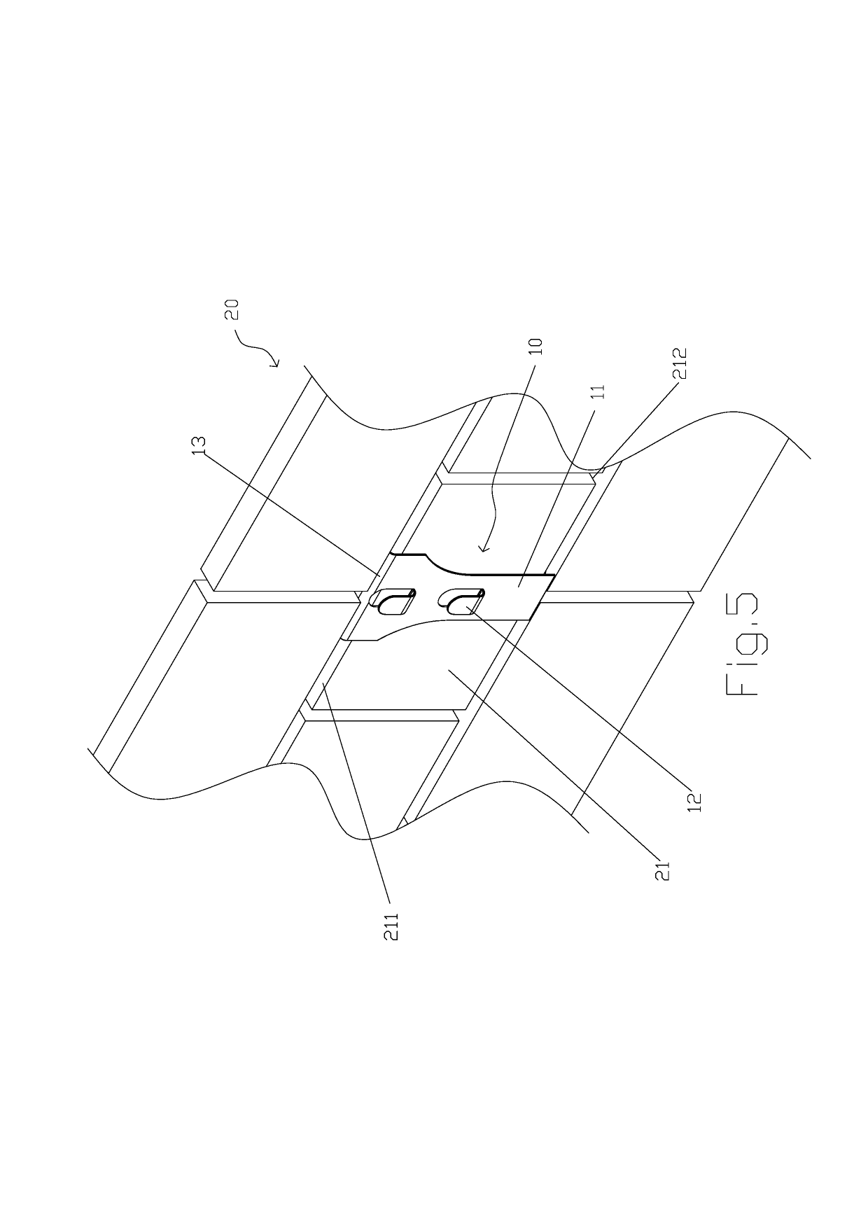

FIG. 6 is exploded three-dimensional schematic view of the present invention.

FIG. 7 is an assembled three-dimensional schematic view of the present invention.

FIG. 8 is a side schematic view of the present invention.

FIG. 9 is a three-dimensional schematic view of the present invention assembled to a single brick.

FIG. 10 is a side schematic view of the present invention assembled to a single brick.

FIG. 11 is a side schematic view of the present invention showing a hook body assembled to a single brick when suspended with a load.

FIG. 12 is a three-dimensional schematic view of the present invention assembled to a brick wall.

### DETAILED DESCRIPTION OF THE PREFERRED EMBODIMENTS

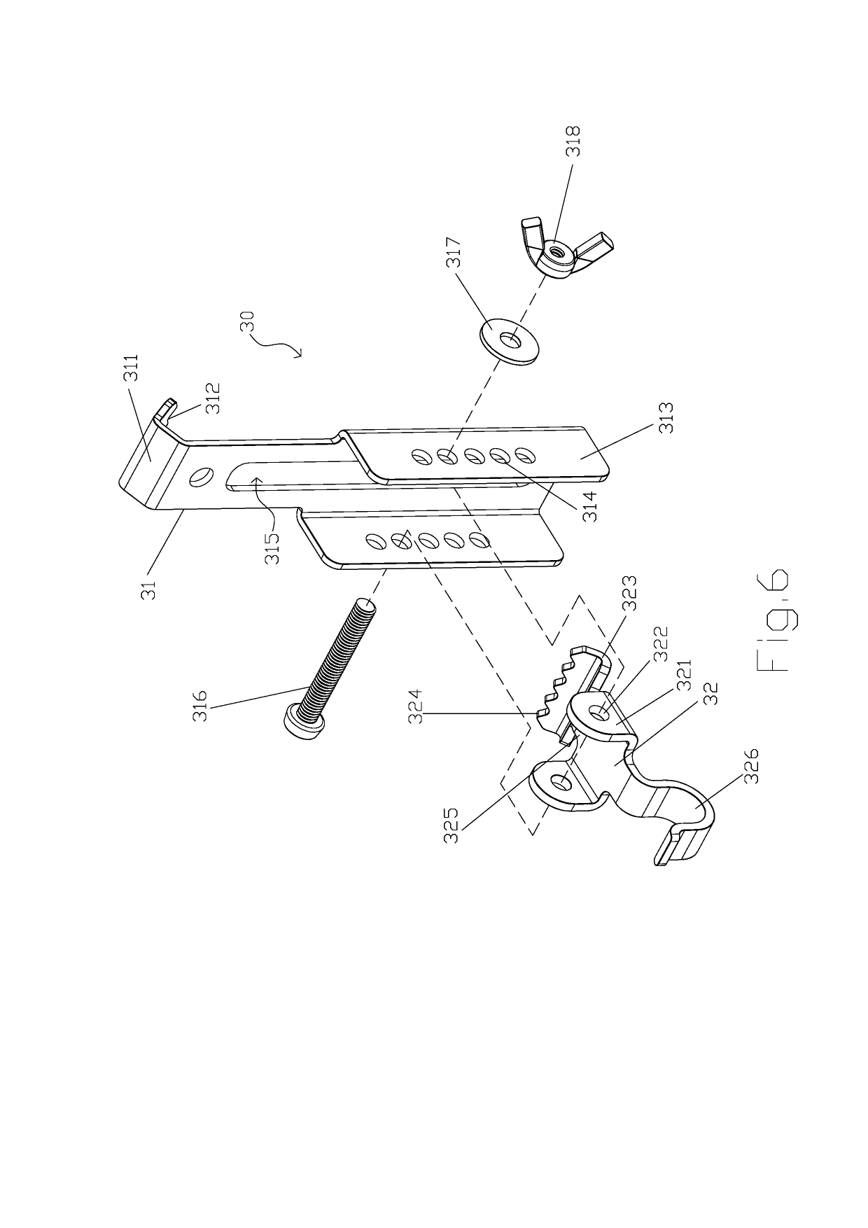

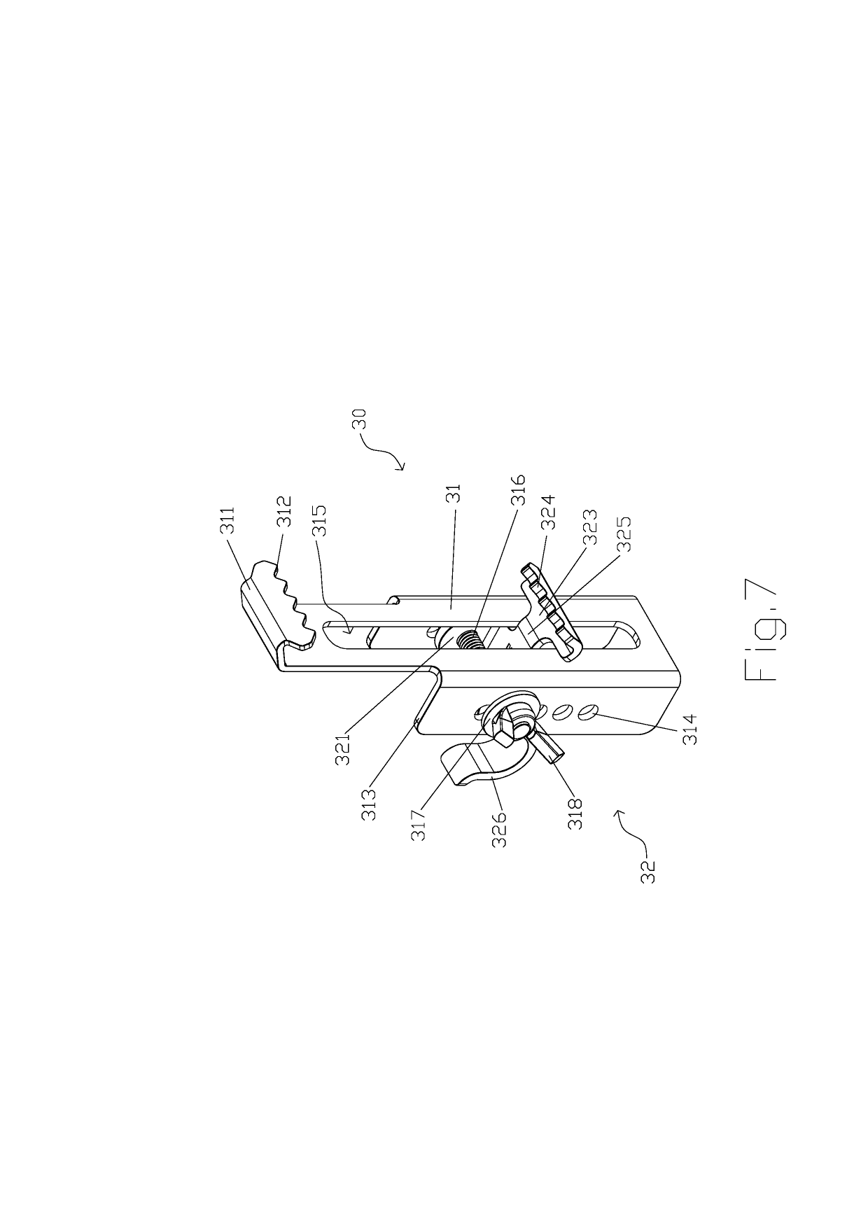

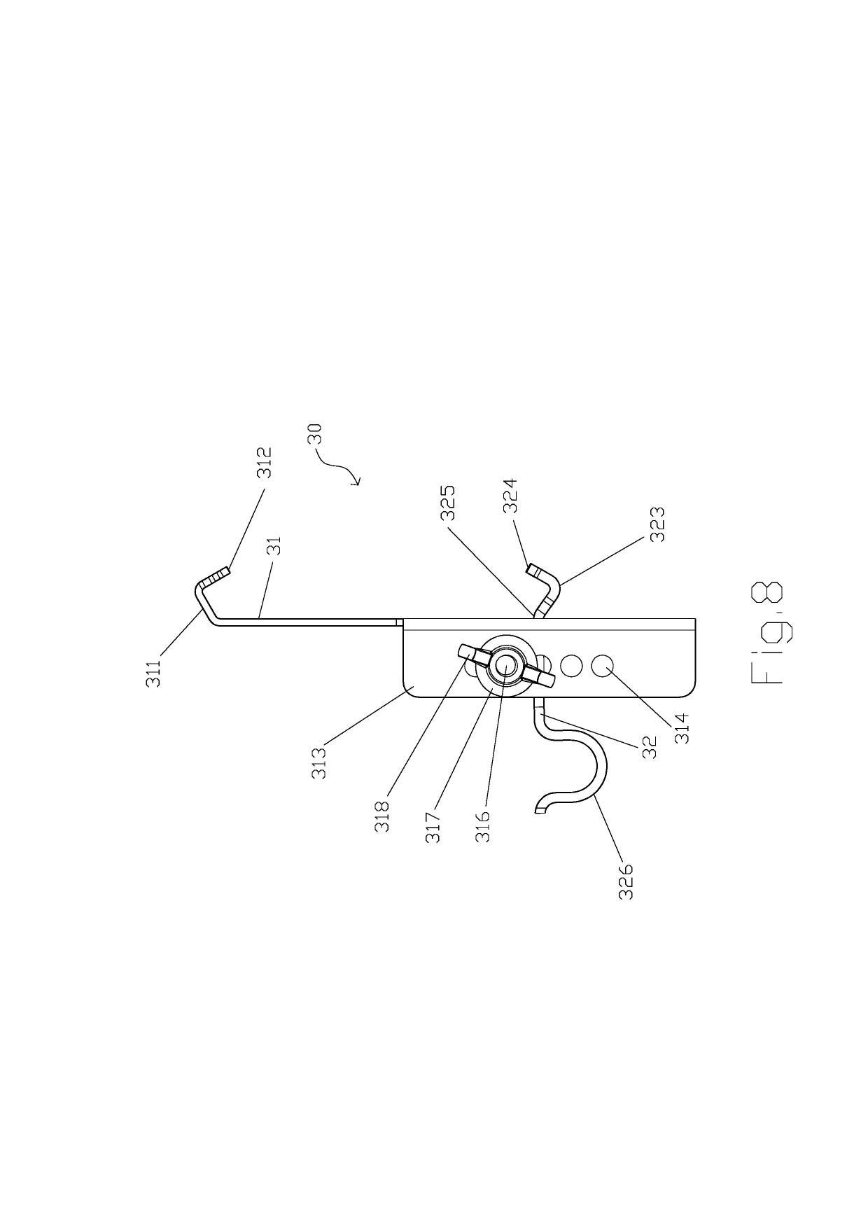

Referring to FIGS. 6, 7, and 8, which show an hook structure for clamping to brick wall of the present invention, comprising a hook 30 that is composed of a suspending body 31 pin connected to a hook body 32, wherein the suspending body 31 is a plate. The top portion of the suspending body 31 is configured with a backward bent inverted U-shaped body 311, and the rear end of the inverted U-shaped body 311 is configured with serrated upper gripping teeth 312. A protruding plate 313 is provided on each side of the lower half of the suspending body 31, and each of the protruding plates 313 is provided with a plurality of positioning holes 314, which are correspondingly aligned from the top to the bottom of the protruding plates 313. The center position of the suspending body 31 is provided with a long hole 315, which is positioned in a vertical direction. The hook body 32 is pin connected between the two protruding plates 313 in a horizontal state. Two sides of the hook body 32 are respectively configured with a lug 321, each of which is provided with a through hole 322. A bolt column 316 penetrates the positioning holes 314 of the protruding plates 313 and the through holes 322 of the lugs 321, with the protruding end of the bolt column 316 being fixed on one side of the protruding plates 313 by means of a washer 317 and a butterfly nut 318. The bolt column 316 penetrates and joins one aligned pair of the positioning holes 314 of the protruding plates 313 to pin connect the hook body 32 therebetween. Calibrations (not shown in the drawings to avoid confusion with the component numbers in the drawings) are engraved next to each of the positioning holes 314, wherein the calibrations mark the height of a brick 41, making it easy for the consumer to see and adjust the height of the hook body 32. The rear end of the hook body 32 is configured with a hook claw 323, the rear end of which is configured with serrated lower gripping teeth 324. The hook body 32 has a retracting portion 325 close to the hook claw 323, wherein the retracting portion 325 corresponds to the position of the long hole 315 of the suspending body 31, thereby enabling the hook claw 323 to rotatably penetrate the long hole 315 while allowing the retracting portion 325 to be positioned in the long hole 315, further enabling the hook claw 323 to rotatably restore to a horizontal position. The hook claw 323 and the lower gripping teeth 324 protrude from the rear surface of the suspending body 31, and the length of the protrusion enables the end portion of the lower gripping teeth 324 of the hook body 32 and the end portion of the upper gripping teeth 312 to be correspondingly aligned. The front end of the hook body 32 has a curved hook 326, and because the hook body 32 is pin connected to the suspending body 31 with one pair of the aligned positioning holes 314 serving as a pivot center, the hook body 32 operates on a lever principle, whereby the heavier the downward load on the curved hook 326, the less effort it takes to exert an upward acting force on the hook claw 323.

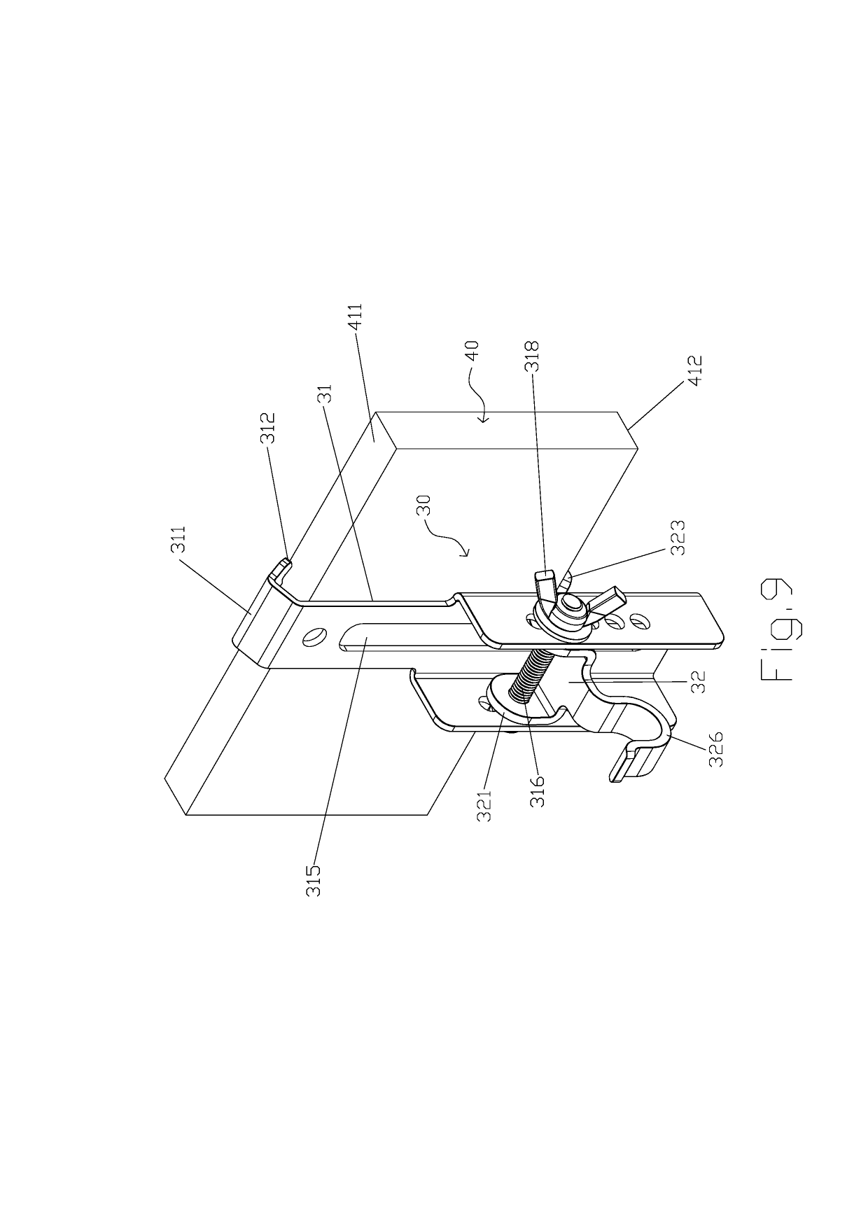

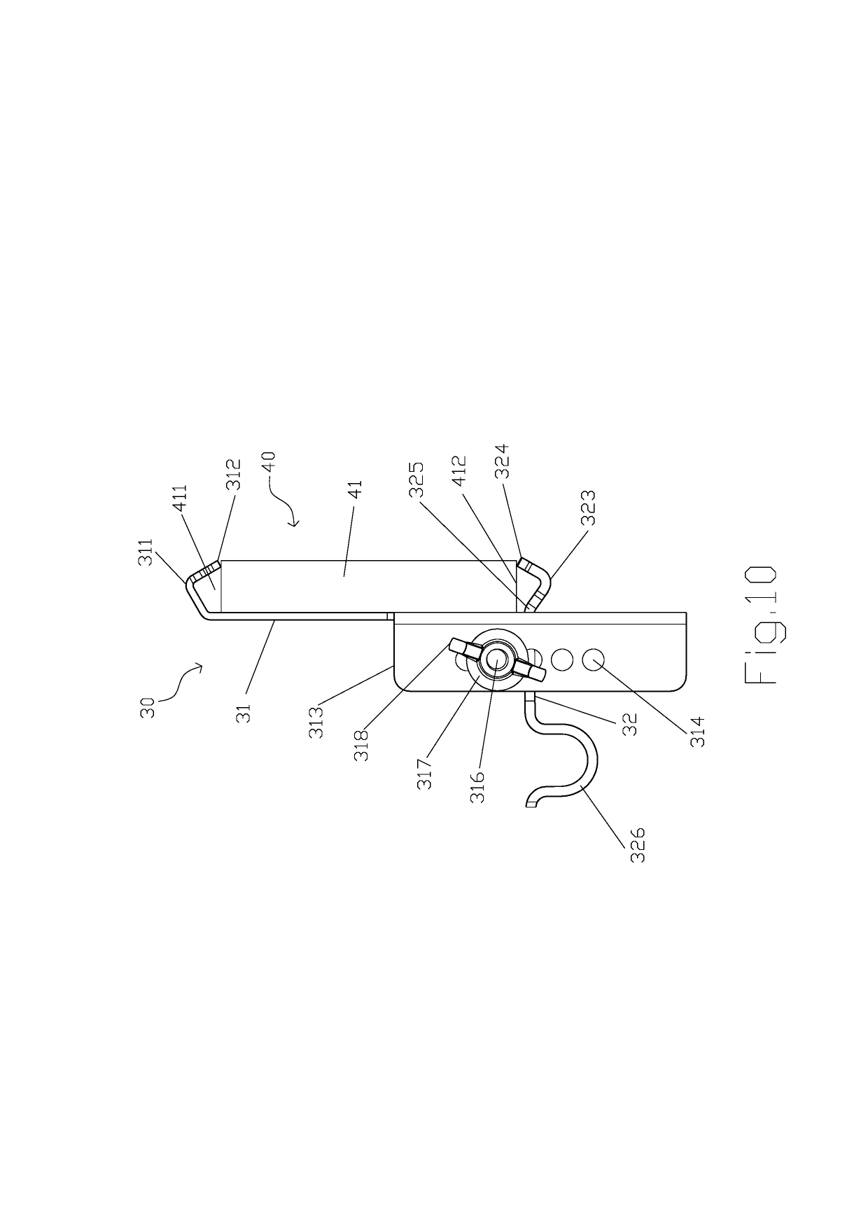

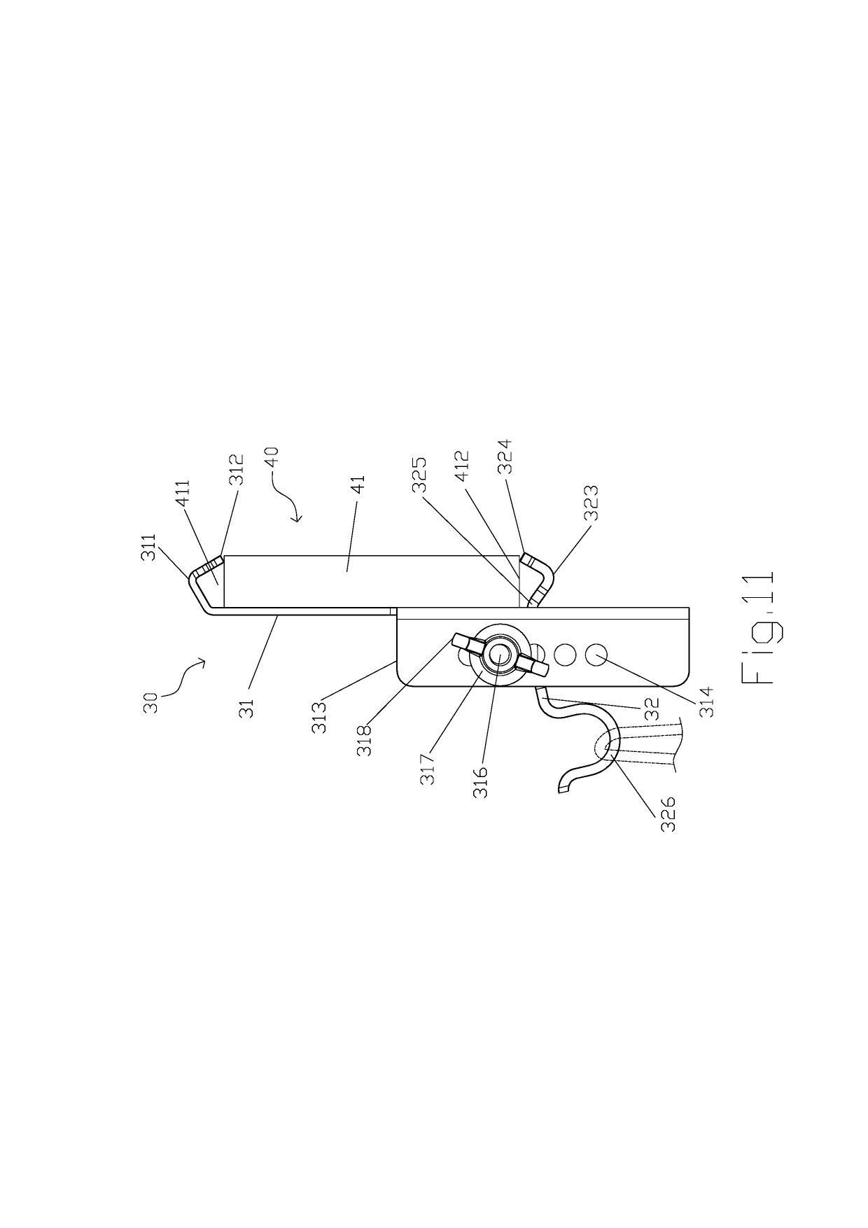

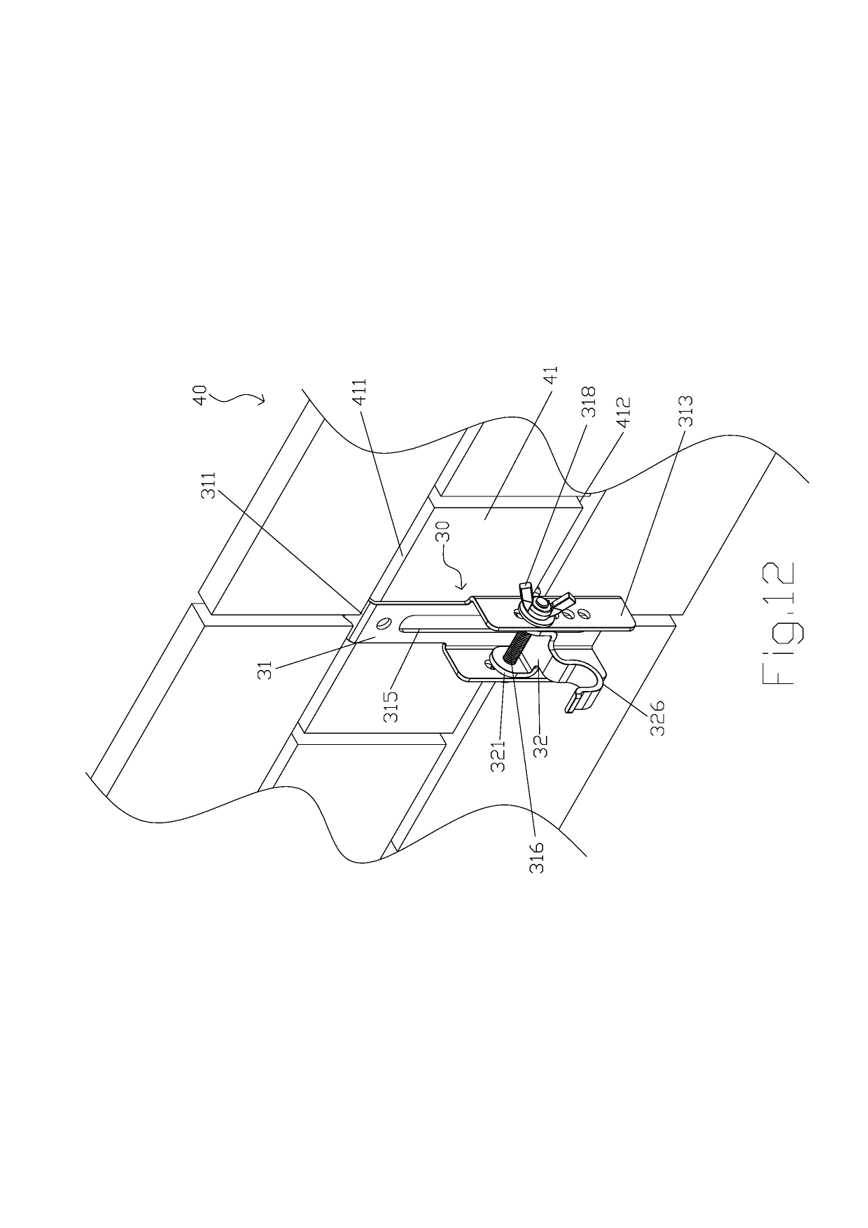

According to the above-described structural assembly, when using the present invention, the hook claw 323 is first made to rotatably penetrate the long hole 315 and protrude through the rear surface of the suspending body 31, then the hook claw 323 is further rotatably restored to a horizontal position. The position of the hook claw 323 is then adjusted according to the required height. The suspending body 31 is then first hooked onto a brick wall 40 by gripping the top surface 411 of one of the bricks 41 of the brick wall 40 using the upper gripping teeth 312 of the suspending body 31 (as shown in FIGS. 9, 10, and 12), whereupon the hook claw 323 of the hook body 32 is made to grip a bottom surface 412 of the brick 41, and one pair of the aligned positioning holes 314 in the protruding plate 313 is selected for the bolt column 316 to pass therethrough as well as the through holes 322 of the lugs 321, whereafter the outer end of the bolt column 316 is fixed with the washer 317 and the butterfly nut 318, thereby completing adjustment of the height of the hook body 32 pivoted between the two protruding plates 313. After the butterfly nut 318 is screwed tight on the bolt column 316, the lower gripping teeth 324 of the hook claw 323 grip the bottom surface 412 of the brick 41, and the suspending body 31 and the hook body 32 are hooked on to the brick wall 40. When the curved hook 326 (used for suspending objects) of the hook body 32 is loaded with an object, the heavier the weight of the object suspended on the curved hook 326, the stronger the gripping strength of the lower gripping teeth 324 on the hook body 32 on the bottom surface 412 of the brick 41 (compare FIGS. 10 and 11).

The present invention is provided with the following advantages:

1. The height of the hook body 32 can be adjusted according to the height of the brick 41; moreover, the present invention is provided with a plurality of positioning holes 314, which enable height adjustment to suit the height of nearly all regional bricks 41.

2. Similar to hooks of the prior art, the present invention eliminates the need to drive nails into the brick wall 40, and thus prevents damage thereto.

3. Apart from the upper gripping teeth 312 gripping the top surface 411 of the brick 41, the lower gripping teeth 324 of the present invention exert two forces gripping the bottom surface 412 of the brick 41, i.e., after tightening the butterfly nut 318 on the bolt column 316, one of the forces is exerted by the lower gripping teeth 324 of the hook claw 323 gripping the bottom surface 412 of the brick 41; as for the other force, the weight of an object suspended from the curved hook 326 causes a lever principle to react on the lower gripping teeth 324 to push upward against the bottom surface 412 of the brick 41.

4. The distance from the curved hook 326 to the positioning holes 314 is greater than the distance from the hook claw 323 to the positioning holes 314, thus, after loading a weight onto the curved hook 326, effort is saved in increasing the upward thrust force on the hook claw 323.

5. The heavier the weight of an object suspended on the curved hook 326, the stronger the gripping strength of the lower gripping teeth 324 on the hook body 32 on the bottom surface 412 of the brick 41, thus eliminating the shortcomings of traditional hooks which fall off when loaded with heavy objects.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A hook structure for clamping to brick wall, comprising a suspending body, the suspending body is a plate, the top portion of which is configured with a backward bent inverted U-shaped body, an end of the inverted U-shaped body is configured with a serrated upper gripping teeth, and a protruding plate is provided on each side of the suspending body;
wherein, the suspending body is pin connected to a horizontal hook body, and each of the protruding plates is provided with a plurality of positioning holes, the hook body is pin connected between the two protruding plates, and two sides of the hook body are respectively configured with a lug, which are joined to an aligned pair of the positioning holes of the protruding plates; a rear end of the hook body is configured with a hook claw, and a rear end of the hook claw is configured with a serrated lower gripping teeth, a front end of the hook body has a curved hook;
accordingly, the upper gripping teeth grips a top surface of a brick in a brick wall, and the plurality of positioning holes enable adjusting the height position of the hook body; the lower gripping teeth of the hook body grips a bottom surface of the brick, and the heavier the weight of an object suspended on the curved hook, the stronger the gripping strength of the lower gripping teeth of the hook body on the bottom surface of the brick.

2. The hook structure for clamping to brick wall according to claim 1, wherein each of the two lugs of the hook body is provided with a through hole; a bolt column penetrates the positioning holes of the protruding plates and the through holes of the lugs, and a protruding end of the bolt column is fixed on one side of the protruding plates by means of a washer and a butterfly nut.

3. The hook structure for clamping to brick wall according to claim 1, wherein the hook body has a retracting portion close to the hook claw and positionally corresponding to a long hole provided in the suspending body; the long hole is formed in a vertical direction, thereby enabling the hook claw to rotatably penetrate the long hole while enabling the retracting portion to be located in the long hole.

4. The hook structure for clamping to brick wall according to claim 1, wherein an end portion of the lower gripping teeth of the hook body and an end portion of the upper gripping teeth are correspondingly aligned.

5. The hook structure for clamping to brick wall according to claim 1, wherein the distance from the front curved hook to the positioning holes is greater than the distance from the rear hook claw to the positioning holes.
